(19) United States
(12) Patent Application Publication
(10) Pub. No.: US 2008/0094318 A1
(43) Pub. Date: Apr. 24, 2008

(54) Plasma display device

(76) Inventors: Isao Furukawa, Tama (JP); Takayuki Kobayashi, Machida (JP); Naoki Itokawa, Yokohama (JP); Makoto Onozawa, Yokohama (JP); Tomokatsu Kishi, Yokosuka (JP)

Correspondence Address: MCDERMOTT WILL & EMERY LLP, 600 13TH STREET, N.W., WASHINGTON, DC, 20005-3096, US

(21) Appl. No.: 11/798,327

(22) Filed: May 11, 2007

(30) Foreign Application Priority Data
Oct. 24, 2006 (JP) 2006-288704

(51) Int. Cl. G09G 3/28

(52) U.S. Cl. 345/67

(57) ABSTRACT

A plasma display device characterized by having a plurality of first electrodes which are provided on a first substrate, a plurality of second electrodes which are provided on the first substrate and for causing discharge between the plurality of first electrodes and themselves, a plurality of third electrodes which are provided in a second substrate to intersect the first and second electrodes, and a plurality of fourth electrodes which are provided between the plurality of first and second electrodes and for controlling discharge between the first and second electrodes, and characterized in that the plurality of first electrodes are fixed to a constant potential.

### CROSS-REFERENCE TO RELATED APPLICATIONS

This application is based upon and claims the benefit of priority from the prior Japanese Patent Application No. 2006-288704, filed on Oct. 24, 2006, the entire contents of which are incorporated herein by reference.

### BACKGROUND OF THE INVENTION

1. Field of the Invention

The present invention relates to a plasma display device.

2. Description of the Related Art

Patent Document 1 which is described below discloses the method for driving a plasma display panel which applies waveforms having a reset function, an address function and a sustain discharge function to scan (Y) electrodes with sustain (X) electrodes biased at a ground voltage. In this manner, the board which drives the sustain electrodes and the switch for supplying the ground voltage can be eliminated, and thereby, the cost of the drive board can be saved.

[Patent Document 1] Japanese Patent Application Laid-open No. 2005-338839

However, in Patent Document 1, the case of performing interlaced display is not taken into consideration. The sustain electrodes are biased at the ground voltage, and the voltage waveforms are applied to the scan electrodes. Therefore, interlaced display cannot be performed.

### SUMMARY OF THE INVENTION

An object of the present invention is to provide a plasma display device capable of performing interlaced display while fixing first electrodes (for example, sustain electrodes) to a constant potential.

A plasma display device of the present invention is characterized by having a plurality of first electrodes which are provided on a first substrate, a plurality of second electrodes which are provided on the first substrate and are for causing discharge between the aforesaid plurality of first electrodes and themselves, a plurality of third electrodes which are provided in a second substrate to intersect the aforesaid first and second electrodes, and a plurality of fourth electrodes which are provided between the aforesaid plurality of first and second electrodes and are for controlling discharge between the aforesaid first and second electrodes, and characterized in that the aforesaid plurality of first electrodes are fixed to a constant potential.

### BRIEF DESCRIPTION OF THE DRAWINGS

FIG. 1 is a diagram showing a configuration example of a plasma display device according to a first embodiment of the present invention;

FIG. 2 is an exploded perspective view showing a structure example of a plasma display panel;

FIG. 3 is a plane view of an X electrode, a Y electrode and a Z electrode;

FIG. 4 is a plane view showing a configuration example of the plasma display panel of this embodiment;

FIG. 5 is a sectional view showing a configuration example of the plasma display panel of this embodiment;

FIG. 6 is a timing chart for explaining an operation example of a reset period, an address period and a sustain discharge period of the plasma display device of this embodiment;

FIG. 7 is an enlarged diagram of a voltage waveform of the sustain discharge period;

FIG. 8 is a sectional view showing discharge of the plasma display panel;

FIG. 9 is an enlarged diagram of the voltage waveform of the sustain discharge period according to a second embodiment of the present invention;

FIG. 10 is an enlarged diagram of the voltage waveform of the sustain discharge period according to a third embodiment of the present invention;

FIG. 11 is an enlarged diagram of the voltage waveform of the sustain discharge period according to a fourth embodiment of the present invention;

FIG. 12 is a plane view showing a configuration example of a plasma display panel of an ALIS (Alternate Lighting of Surfaces) method;

FIG. 13 is a sectional view showing a configuration example of the plasma display panel of the ALIS method;

FIG. 14 is a view showing interlaced display of the plasma display panel;

FIG. 15 is a diagram showing voltage waveform examples of the X electrodes and the Y electrodes of the odd number field;

FIG. 16 is a diagram showing a configuration example of a plasma display device with X electrodes fixed to a ground potential; and

FIG. 17 is a timing chart for explaining an operation example of a reset period, an address period and a sustain discharge period of the plasma display device in FIG. 16.

### DETAILED DESCRIPTION OF THE PREFERRED EMBODIMENTS

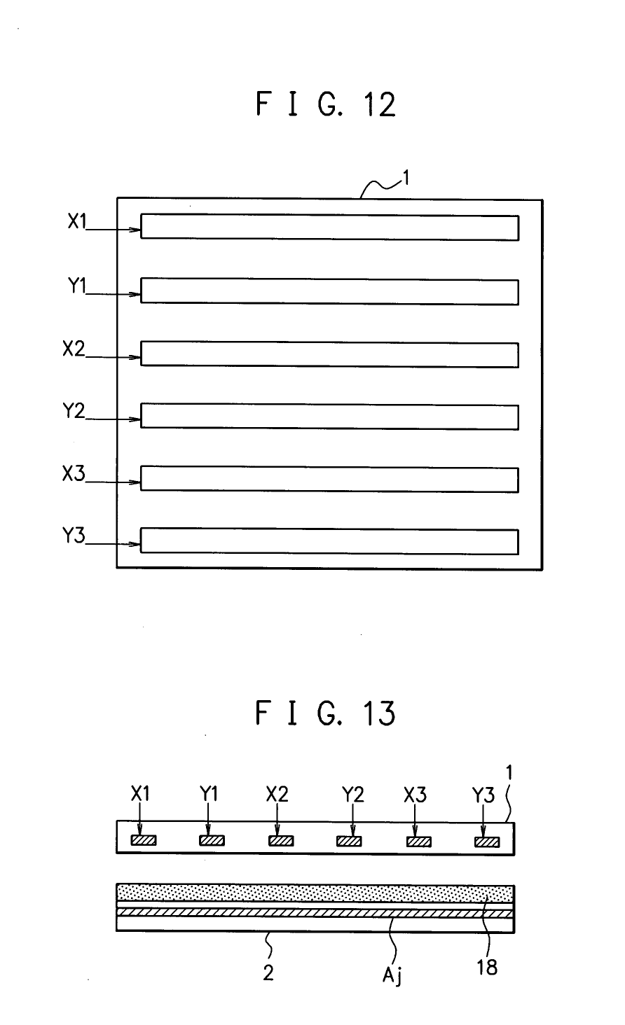

FIG. 12 is a plane view showing a configuration example of a plasma display panel of an ALIS (Alternate Lighting of Surfaces) method, and FIG. 13 is a sectional view of the same. X (sustain) electrodes X1, X2, X3, . . . and Y (scan) electrodes Y1, Y2, Y3 . . . are alternately disposed on a front glass substrate 1. An address electrode Aj and a phosphor 18 are provided on a rear glass substrate 2.

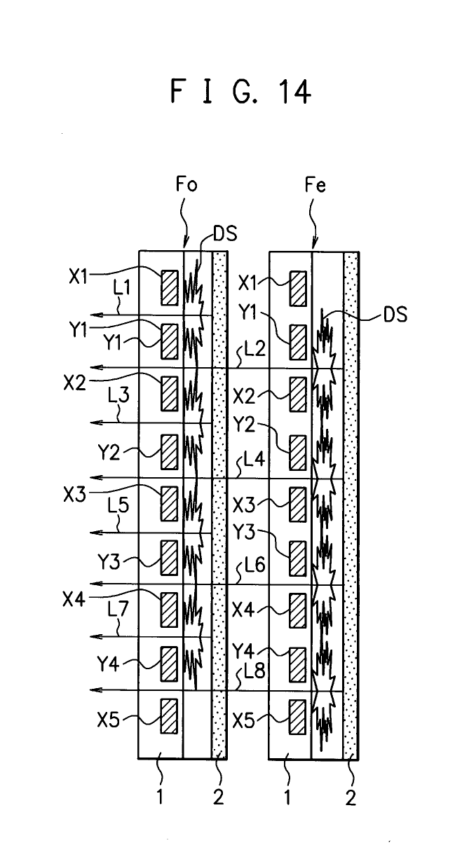

FIG. 14 is a view showing interlaced display of a plasma display panel. In the interlaced display, an odd number field Fo and an even number field Fe are alternately displayed. In the odd number field Fo, the plasma display panel having the front glass substrate 1 and the rear glass substrate 2 display odd lines L1, L3, L5, L7, . . . every 1/60 seconds. In the even number field Fe, the plasma display panel having the front glass substrate 1 and the rear glass substrate 2 display even number lines L2, L4, L6, L8, . . . every 1/60 seconds. For example, the line L1 is displayed by discharge DS of the display cell between the X electrode X1 and the Y electrode Y1, the line L2 is displayed by the discharge DS of the display cell between the Y electrode Y1 and the X electrode X2, and the line L3 is displayed by the discharge DS of the display cell between the X electrode X2 and the Y electrode Y2.

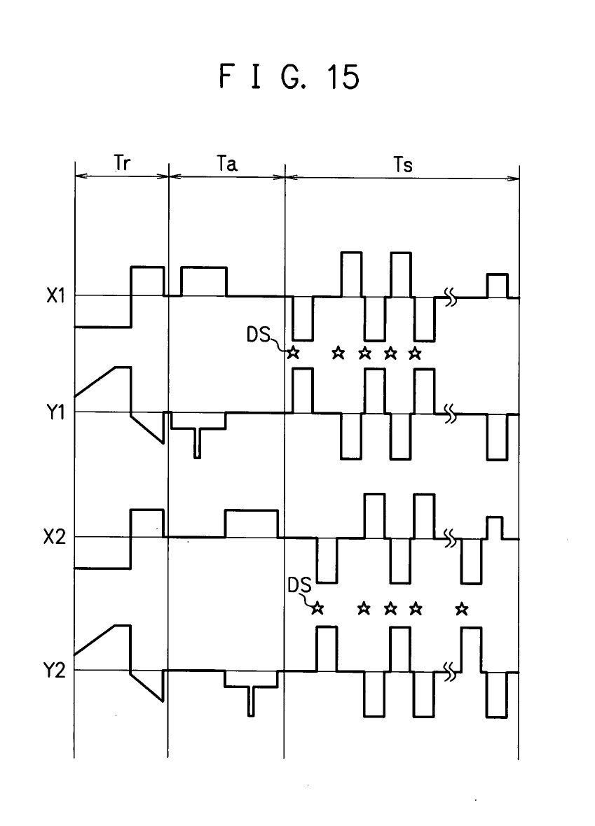

FIG. 15 is a diagram showing voltage waveform examples of the X electrodes and the Y electrodes of the odd number field Fo. The odd number field Fo is constituted of a plurality of subfields. Each of the subfields has a reset period Tr, an address period Ta and a sustain discharge period Ts. In the reset period Tr, the display cell is reset. In the address period Ta, the display cell to be caused to emit light is selected. In the sustain discharge period Ts, the selected display cell emits light by the discharge DS for each sustain discharge pulse. The display cell between the X electrode X1 and the Y electrode Y1 constitute the line L1, and the display cell between the X electrode X2 and the Y electrode Y2 constitute the line L3. In the display cells of the odd number lines L1, L3 and the like, a high voltage is applied by the sustain discharge pulse, the discharge DS occurs, and light is emitted by the phosphor 18. The display cell between the Y electrode Y1 and the X electrode X2 constitute the line L2. In the Line L2, the sustain discharge pulse of the same phase is applied to the Y electrode Y1 and the X electrode X2. Therefore, the voltage between the Y electrode Y1 and the X electrode X2 is substantially 0V, and discharge and light emission do not occur. As above, in the odd field Fo, only the odd number lines L1, L3 and the like are capable of emitting light, and the odd number lines L2, L4 and the like do not emit light.

In the even number field Fe, by replacing the voltage waveforms of the odd-numbered X electrodes X1, X3 and the like of FIG. 15 with those of the even-numbered X electrodes X2, X4 and the like, only the even number lines L2, L4 and the like are capable of emitting light, and the odd number lines L1, L3 and the like do not emit light.

As above, in the ALIS method, the X electrodes and the Y electrodes are alternately arranged as X1, Y1, X2, and Y2, and the even number lines and the odd number lines are alternately caused to light every 1/60 seconds. Therefore, when the odd number lines are caused to light, as for the drive waveform during the sustain discharge period Ts, the same drive waveform is applied to the odd-numbered X electrodes X1 and the like and the even-numbered Y electrodes Y2 and the like, and the same drive waveform is applied to the even-numbered X electrodes X2 and the like and the odd-numbered Y electrodes Y1 and the like. Thereby, discharge is not caused between the electrodes X2 and Y1 and between the electrodes X3 and Y2, and discharge can be caused between the electrodes X1 and Y1 and between the electrode X2 and Y2. When the even number lines are caused to light, the same operation can be performed by replacing the drive waveforms of the odd-numbered X electrode X1 and the like with those of the even-numbered X electrode X2 and the like. In this manner, with the ALIS method, interlaced display is enabled and higher definition can be achieved.

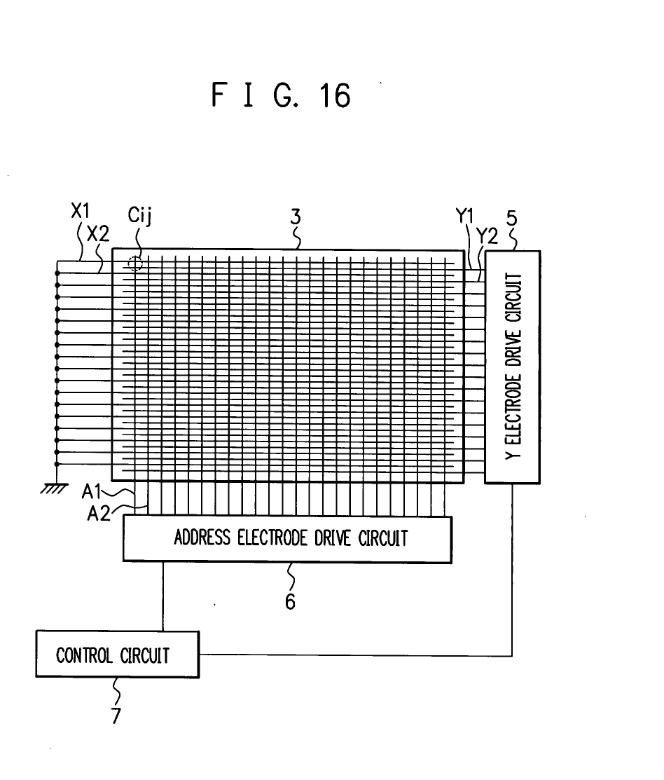

FIG. 16 is a view showing a configuration example of a plasma display device with the X electrodes fixed to the ground potential. A control circuit 7 controls a Y electrode drive circuit 5 and an address electrode drive circuit 6. A plurality of X electrodes X1, X2, . . . are fixed to the ground potential. Hereinafter, each of the X electrodes X1, X2, . . . or a generic name of them is called an X electrode Xi, and i means a subscript. The Y electrode drive circuit 5 supplies a predetermined voltage to a plurality of Y electrodes Y1, Y2, . . . . Hereinafter, each of the Y electrodes Y1, Y2, . . . or a generic name of them is called a Y electrode Y1, and i means a subscript. The address electrode drive circuit 6 supplies a predetermined voltage to a plurality of address electrodes A1, A2, . . . . Hereinafter, each of the address electrodes A1, A2, . . . or a generic name of them is called an address electrode Aj, and j means a subscript. Since an X electrode drive circuit for supplying a voltage to the X electrode Xi is not required, cost can be reduced.

In the plasma display panel 3, the Y electrode Yi and the X electrode Xi form rows extending in parallel in the horizontal direction, and the address electrode Aj forms columns extending in the vertical direction. The Y electrode Yi and the X electrode Xi are alternately disposed in the vertical direction. The Y electrode Yi and the address electrode Aj form a two-dimensional matrix of row i and column j. A display cell Cij is formed by an intersection point of the Y electrode Yi and the address electrode Aj and the X electrode Xi adjacent to correspond to it. The display cell Cij corresponds to a pixel, and the plasma display panel 3 can display a two-dimensional image.

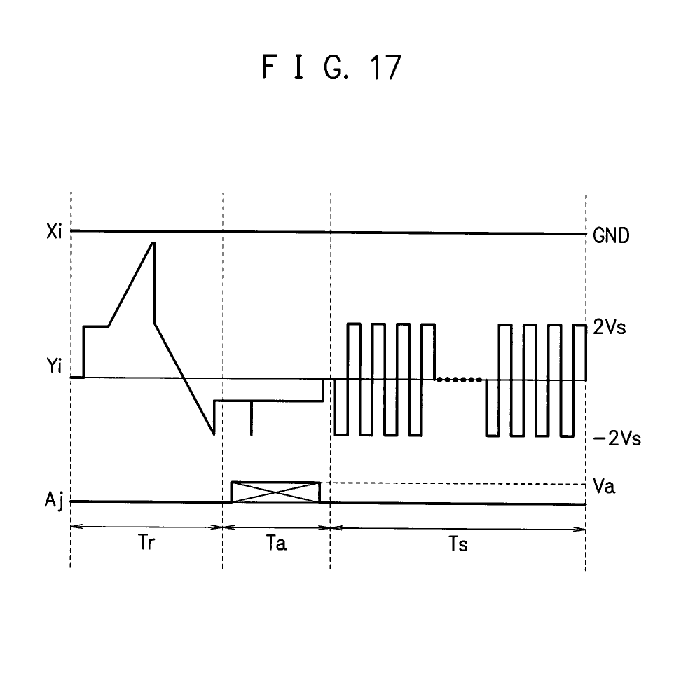

FIG. 17 is a timing chart for explaining an operation example of the reset period Tr, the address period Ta and the sustain discharge period Ts of the plasma display device in FIG. 16. All the X electrodes Xi are fixed to the ground potential GND.

In the reset period Tr, a predetermined voltage is applied to the Y electrode Yi, and the display cell Cij is initialized.

In the address period Ta, a scan pulse is sequentially scanned and applied to the Y electrodes Y1, Y2, . . . , and an address pulse is applied to the address electrodes Aj to correspond to the scan pulse, whereby the display image is selected. If the address pulse of the address electrode Aj is generated to correspond to the scan pulse of the Y electrode Yi, the display cell of the Y electrode Yi and the X electrode Xi is selected. If the address pulse of the address electrode Aj is not generated to correspond to the scan pulse of the Y electrode Yi, the display cell of the Y electrode Yi and the X electrode Xi is not selected. If the address pulse is generated to correspond to the scan pulse, address discharge between the address electrode Aj and the Y electrode Yi occurs. With the address discharge as the pilot flame, discharge occurs between the X electrode Xi and the Y electrode Yi, negative electric charges are accumulated in the X electrode Xi, and positive electric charges are accumulated in the Y electrode Yi.

In the sustain discharge period Ts, a sustain discharge pulse is applied to the Y electrode Yi, sustain discharge is performed between the X electrode Xi and the Y electrode Yi of the selected display cell to emit light.

Since the X electrode Xi is fixed to the ground potential GND, and a drive waveform is applied to only the Y electrode Yi to drive it, the odd number lights even when the even number line is caused to light, and interlaced display cannot be performed. Thus, the distances between the electrodes Y1 and X2 and between the electrodes Y2 and X3 are made large so that discharge does not occur between those electrodes, and so that discharge occurs only between the electrodes X1 and Y1 and between the electrodes X2 and Y2 and the like. In this case, the resolution becomes half. In order to realize higher definition, the number of electrodes needs to be increased, and by increase of the number of scan ICs in the Y electrode drive circuit 5, or the like, the cost is increased.

Hereinafter, plasma display device capable of performing interlaced display while fixing the X electrodes to the ground potential will be shown.

### First Embodiment

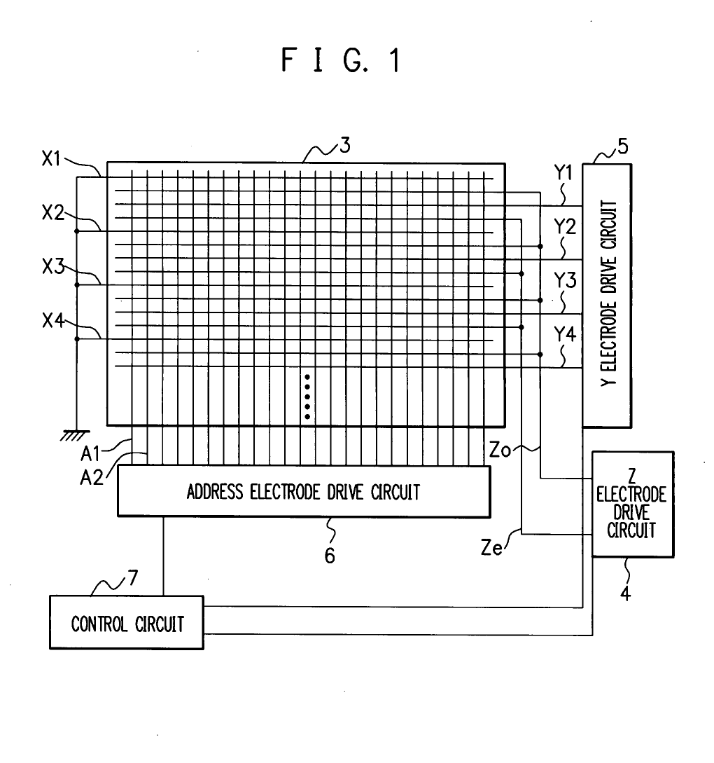

FIG. 1 is a view showing a configuration example of a plasma display device according to a first embodiment of the present invention. The control circuit 7 controls the Y electrode drive circuit 5, a Z electrode drive circuit 4 and the address electrode drive circuit 6. A plurality of X electrodes X1, X2, . . . are fixed to the ground potential. Hereinafter, each of the X electrodes X1, X2, . . . , or a generic name of them is called the X electrode Xi, and i means a subscript. The Y electrode drive circuit 5 supplies a predetermined voltage to a plurality of Y electrodes Y1, Y2, . . . . Hereinafter, each of the Y electrodes Y1, Y2 . . . or a generic name of them is called the Y electrode Yi, and i means a subscript. The Z electrode drive circuit 4 supplies a predetermined voltage to odd-numbered Z electrodes Zo and even-numbered Z electrodes Ze. The address electrode drive circuit 6 supplies a predetermined voltage to a plurality of address electrodes A1, A2, . . . . Hereinafter, each of the address electrodes A1, A2, . . . or a generic name of them is called the address electrode Aj, and j means a subscript.

The X electrode (the first electrode) Xi and the Y electrode (the second electrode) Yi are electrodes for causing sustain discharge. The address electrode (the third electrode) Aj is provided to intersect the X electrode Xi and the Y electrode Yi. The Z electrodes (the fourth electrodes) Zo and Ze are provided between the X electrodes Xi and the Y electrodes Yi, and are the electrodes for controlling the discharge between the X electrodes Xi and the Y electrodes Yi.

In the plasma display panel 3, the Y electrodes Yi and the X electrodes Xi form the rows extending in parallel in the horizontal direction, and the address electrodes Aj form the columns extending in the vertical direction. The Y electrodes Yi and the X electrodes Xi are disposed alternately in the vertical direction. The Y electrode Yi and the address electrode Aj form the two-dimensional matrix of the row i and the column j. The display cell Cij is formed by the intersection point of the Y electrode Yi and the address electrode Aj and the X electrode Xi adjacent to correspond to it. The display cell Cij corresponds to a pixel, and the plasma display panel 3 can display a two-dimensional image.

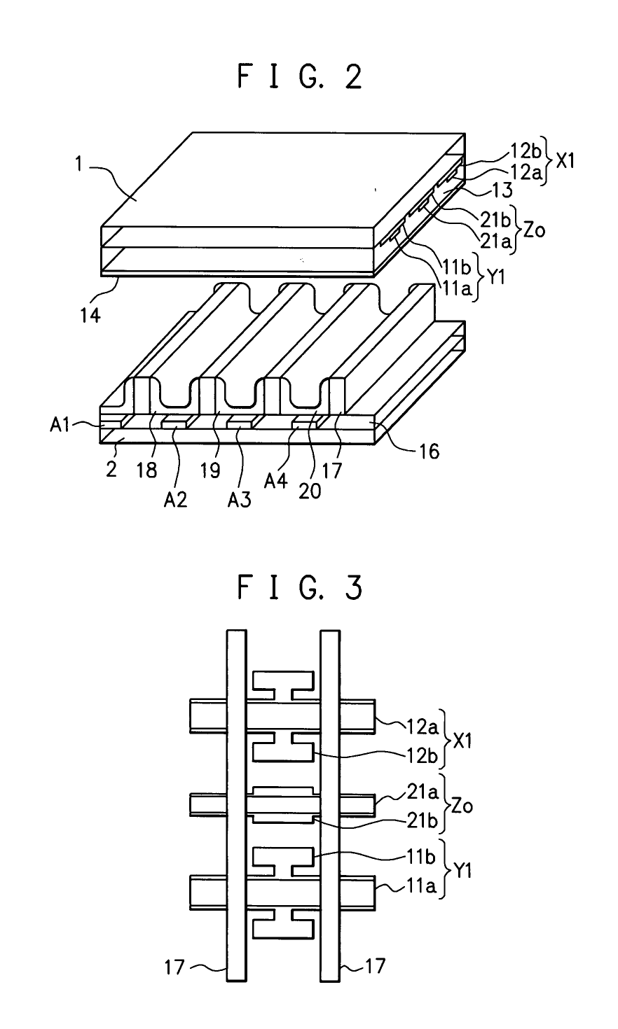

FIG. 2 is an exploded perspective view showing a structure example of the plasma display panel 3, and FIG. 3 is a plane view of the X electrode, Y electrode and Z electrode. The X electrode Xi, the Y electrode Yi and the Z electrodes Zo and Ze are formed on the front glass substrate 1. The X electrode Xi has a bus electrode 12a and a transparent electrode 12b. The Y electrode Yi has a bus electrode 11a and a transparent electrode 11b. The Z electrodes Zo and Ze each have a bus electrode 21a and a transparent electrode 21b. On them, a dielectric layer 13 for insulating them from the discharge space is deposited. Further, thereon, an MgO (magnesium oxide) protective layer 14 is deposited. Meanwhile, the address electrodes Aj are formed on the rear glass substrate 2 disposed to be opposed to the front glass substrate 1. A dielectric layer 16 is deposited thereon. Further, thereon, phosphors 18 to 20 are adhered. The phosphors 18 to 20 which are red, blue and green are arranged in the stripe shapes in accordance to color and coated on the inner surfaces of partition walls 17. The phosphors 18 to 20 are excited by discharge between the X electrode Xi and the Y electrode Yi to emit each color. An Ne+Xe penning gas or the like is sealed in the discharge space between the front glass substrate 1 and the rear glass substrate 2.

By sustain discharge between the X electrode X1 and the Y electrode Y1, the display cell emits light. The Z electrode Zo is the electrode for controlling the sustain discharge between the X electrode X1 and the Y electrode Y1.

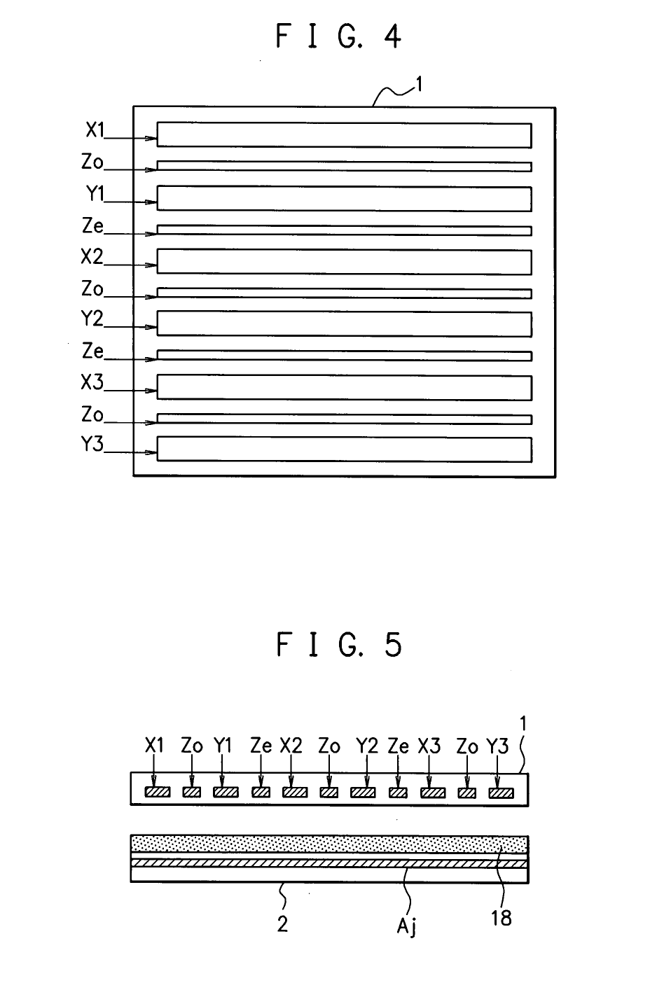

FIG. 4 is a plane view showing a configuration example of the plasma display panel 3 of this embodiment, and FIG. 5 is a sectional view of the same. On the front glass substrate 1, the X electrodes X1, X2, X3, . . . and the Y electrodes Y1, Y2, Y3, . . . are alternately disposed, and the Z electrodes Zo and Ze are provided between the X electrodes and the Y electrodes. The odd-numbered Z electrodes Zo are provided between the X electrodes Xi and the Y electrodes Yi, and control the display of the odd number lines. The even-numbered Z electrodes Ze are provided between the Y electrodes Yi and the X electrodes Xi+1, and control the display of the even number lines. Namely, on the front glass substrate 1, the X electrode X1, the Z electrode Zo, the Y electrode Y1, the Z electrode Ze, the X electrode X2, the Z electrode Zo, the Y electrode Y2, the Z electrode Ze, the X electrode X3, the Z electrode Zo, the Y electrode Y3, . . . are arranged in this sequence. On the rear glass substrate 2, the address electrode Aj and the phosphor 18 are provided.

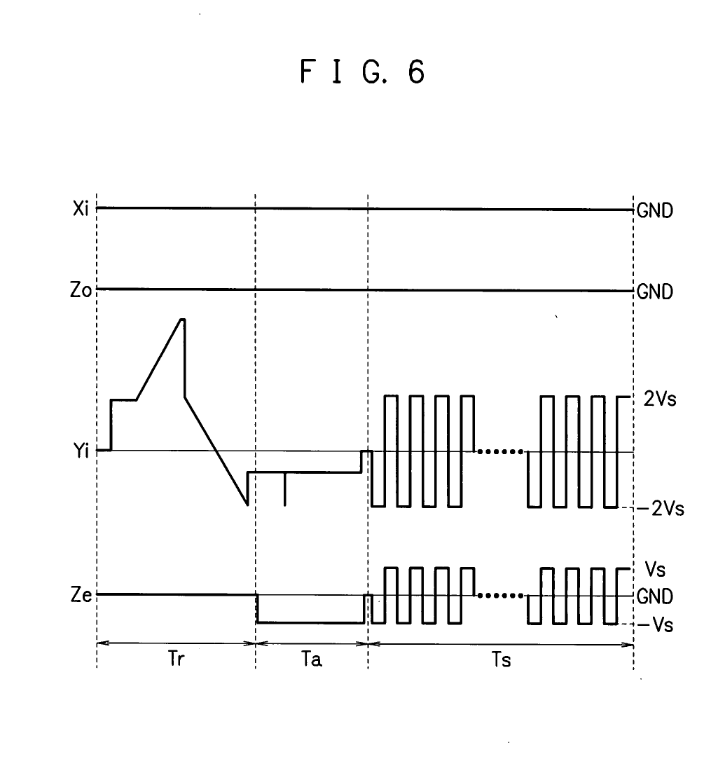

FIG. 6 is a timing chart for explaining the operation example of the reset period Tr, the address period Ta and the sustain discharge period Ts of the plasma display device of this embodiment. All the X electrodes Xi are fixed to the ground potential GND. Here, the example of the odd number field which displays the odd number line between the X electrode Xi and the Y electrode Yi is shown.

In the reset period Tr, a predetermined voltage is applied to the Y electrode Yi, and initialization of the display cell is performed.

In the address period Ta, the display pixel is selected by scanning and applying a negative scan pulse to the Y electrodes Y1, Y2, . . . , and by applying an address pulse to the address electrode Aj to correspond to the scan pulse. When the odd number line is displayed, the ground potential GND is applied to the odd-numbered Z electrode Zo, and a negative voltage −Vs is applied to the even-numbered Z electrode Ze. When the address pulse of the address electrode Aj is generated to correspond to the scan pulse of the Y electrode Yi, the display cell of the Y electrode Yi and the X electrode Xi is selected. When the address pulse of the address electrode Aj is not generated to correspond to the scan pulse of the Y electrode Yi, the display cell of the Y electrode Yi and the X electrode Xi is not selected. When the address pulse is generated to correspond to the scan pulse, address discharge occurs between the address electrode Aj and the Y electrode Yi. Since the Z electrode Zo is at the ground potential GND, discharge occurs between the X electrode Xi and the Y electrode Yi with the address discharge as the pilot flame, and negative electric charges are accumulated in the X electrode Xi, whereas positive electric charges are accumulated in the Y electrode Yi. Thereby, display of the odd number line constituted of the display cell between the X electrode Xi and the Y electrode Yi can be selected. On the other hand, the negative voltage −Vs is applied to the Z electrode Ze, and therefore, discharge does not occur between the Y electrode Yi and the X electrode Xi+1. Thereby, display of the even number line constituted of the display cell between the Y electrode Yi and the X electrode Xi+1 is not selected.

In the sustain discharge period Ts, a sustain discharge pulse is applied to the Y electrode Yi, the ground potential GND is applied to the Z electrode Zo, a discharge suppression pulse is applied to the Z electrode Ze, sustain discharge is performed between the X electrode Xi and the Y electrode Yi of the selected display cell, and light emission is performed. By applying the ground potential to the Z electrode Zo, the odd number line constituted of the display cell between the X electrode Xi and the Y electrode Yi is displayed by discharge. On the other hand, by applying the discharge suppression pulse to the Z electrode Ze, the even number line constituted of the display cell between the Y electrode Yi and the X electrode Xi+1 has no discharge and is not displayed.

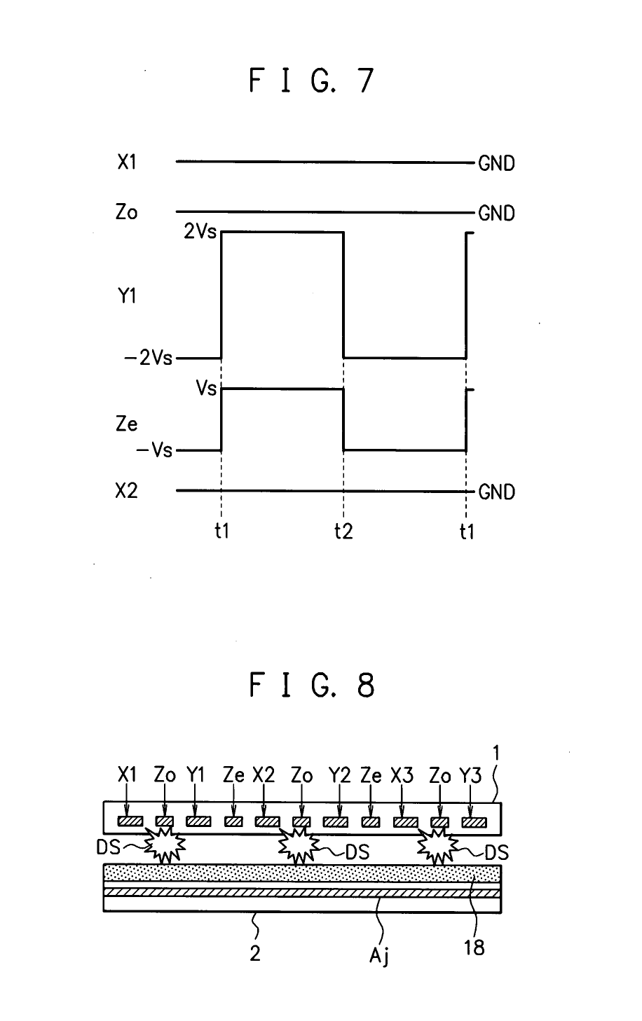

FIG. 7 is an enlarged diagram of a voltage waveform of the above described sustain discharge period Ts, and FIG. 8 is a sectional view showing discharge DS of the plasma display panel corresponding to FIG. 5. All the X electrodes X1, X2, . . . are fixed to the ground potential.

At a time t1, a voltage 2 Vs is applied to the Y electrode Y1, and the ground potential GND is applied to the Z electrode Zo. Therefore, the voltage 2 Vs is applied between the Y electrode Y1 and the Z electrode Zo, and discharge occurs between the Y electrode Y1 and the Z electrode Zo. With the discharge as the pilot flame, the sustain discharge Ds occurs between the Y electrode Y1 and the X electrode X1. Thereby, the odd number line constituted of the display cell between the X electrode X1 and the Y electrode Y1 is displayed.

On the other hand, a voltage Vs is applied to the Z electrode Ze, and only the voltage Vs is applied between the Y electrode Y1 and the Z electrode Ze. Therefore, discharge does not occur between the Y electrode Y1 and the Z electrode Zo. As a result, the sustain discharge DS does not occur between the Y electrode Y1 and the X electrode X2. Thereby, the even number line constituted of the display cell between the Y electrode Y1 and the X electrode X2 is not displayed.

Next, at a time t2, a negative voltage −2 Vs is applied to the Y electrode Y1, and the ground potential GND of the Z electrode Zo is sustained. Therefore, the voltage 2 Vs is applied between the Y electrode Y1 and the Z electrode Zo, and therefore, discharge occurs between the Y electrode Y1 and the Z electrode Zo. With the discharge as the pilot flame, the sustain discharge DS occurs between the Y electrode Y1 and the X electrode X1. Thereby, the odd line constituted of the display cell between the X electrode X1 and the Y electrode Y1 is displayed.

On the other hand, a negative voltage −Vs is applied to the Z electrode Ze, and therefore, only the voltage Vs is applied between the Y electrode Y1 and the Z electrode Ze. Therefore, discharge does not occur between the Y electrode Y1 and the Z electrode Zo. As a result, the sustain discharge DS does not occur between the Y electrode Y1 and the X electrode X2. Thereby, the even number line which is constituted of the display cell between the Y electrode Y1 and the X electrode X2 is not displayed.

With the above voltage waveform as one cycle, the above described operation is repeated.

First voltage pulses of the voltages 2 Vs and −2 Vs are applied to the Y electrode Yi (for example, Y1) for sustain discharge. By applying the same voltage (for example, the ground potential GND) as the X electrode Xi to the Z electrode Zo, discharge between the X electrode Xi (for example, X1) and the Y electrode Yi (for example, Y1) at both sides of the Z electrode Zo is caused. On the other hand, by applying second voltage pulses with the same polarity as the first voltage pulses of the Y electrode Yi (for example, Y1) to the Z electrode Ze, discharge between the Y electrode Yi (for example Y1) and the X electrode Xi+1 (for example, X2) at both sides of the Z electrode Ze is suppressed.

The second voltage pulse of the Z electrode Ze has the same pulse width as and half the voltage of the first voltage pulse of the Y electrode Yi.

This embodiment can perform interlaced display which is described with reference to FIG. 14. In the above description, the case where the odd number lines L1, L3, . . . are displayed in the odd number field Fo is described as an example. In the case of displaying the even number lines L2, L4, . . . in the even number field Fe, the voltage of the Z electrode Zo and the voltage of the Z electrode Ze are replaced with each other.

As described above, according to this embodiment, by providing the Z electrodes, interlaced display can be performed while the X electrodes are fixed to a constant potential (for example, the ground potential). By fixing the X electrodes to a constant potential, the X electrode drive circuit for driving the X electrodes can be eliminated, and cost can be reduced. By performing interlaced display, an image with high definition can be displayed without increasing the number of Y electrodes and the scan ICs for driving them.

### Second Embodiment

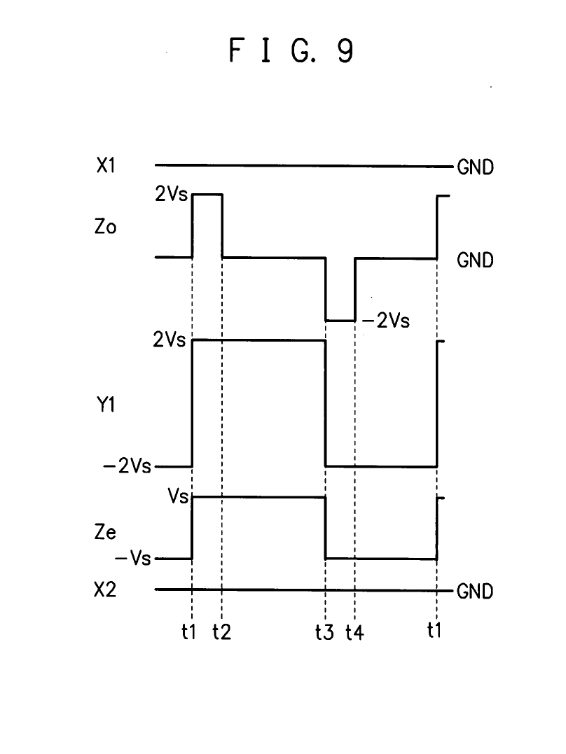

FIG. 9 corresponds to FIG. 7, and is an enlarged diagram of a voltage waveform of the sustain discharge period Ts according a second embodiment of the present invention. Hereinafter, the respect in which this embodiment differs from the first embodiment will be described. As in the first embodiment (FIG. 7), all the X electrodes X1, X2, . . . are fixed to the ground potential.

At the time t1, the voltage 2 Vs is applied to the Y electrode Y1 and the Z electrode Zo, and the voltage Vs is applied to the Z electrode Ze. Since the voltage 2 Vs is applied between the Z electrode Zo and the X electrode X1, discharge occurs between the Z electrode Zo and the X electrode X1. The discharge becomes the pilot discharge for sustain discharge of the subsequent time t2. Since the potential difference between the Z electrode Zo and the Y electrode Y1 is 0 V, discharge does not occur between the Z electrode Zo and the Y electrode Y1.

On the other hand, the voltage Vs is applied to the Z electrode Ze, and therefore, only the voltage Vs is applied between the Z electrode Ze and the X electrode X2, and therefore, discharge does not occur between the Z electrode Ze and the X electrode X2. Since only the voltage Vs is applied between the Z electrode Ze and the Y electrode Y1, discharge does not occur between the Z electrode Ze and the Y electrode Y1.

Next, at the time t2, the ground potential GND is applied to the Z electrode Zo. Since the voltage 2 Vs is applied between the Y electrode Y1 and the Z electrode Zo, discharge occurs between the Y electrode Y1 and the Z electrode Zo. With the discharge as the pilot flame, the sustain discharge DS occurs between the Y electrode Y1 and the X electrode X1. Thereby, the odd number line constituted by the display cell between the X electrode X1 and the Y electrode Y1 is displayed.

On the other hand, the Z electrode Ze sustains the voltage Vs, and therefore, the sustain discharge DS does not occur between the Y electrode Y1 and the X electrode X2. Thereby, the even number line constituted of the display cell between the Y electrode Y1 and the X electrode X2 is not displayed.

Next, at the time t3, the negative voltage −2 Vs is applied to the Y electrode Y1 and the Z electrode Zo, and the negative voltage −Vs is applied to the Z electrode Ze. Since the voltage 2 Vs is applied between the Z electrode Zo and the X electrode X1, discharge occurs between the Z electrode Zo and the X electrode X1. The discharge becomes the pilot discharge for the sustain discharge at the subsequent time t4. Since the potential difference between the Z electrode Zo and the Y electrode Y1 is 0 V, discharge does not occur between the Z electrode Zo and the Y electrode Y1.

On the other hand, the negative voltage −Vs is applied to the Z electrode Ze, and therefore, only the voltage Vs is applied between the Z electrode Ze and the X electrode X2. Therefore, discharge does not occur between the Z electrode Ze and the X electrode X2. Since only the voltage Vs is applied between the Z electrode Ze and the Y electrode Y1, discharge does not occur between the Z electrode Ze and the Y electrode Y1.

Next, at the time t4, the ground potential GND is applied to the Z electrode Zo. Since the voltage 2 Vs is applied between the Y electrode Y1 and the Z electrode Zo, discharge occurs between the Y electrode Y1 and the Z electrode Zo. With the discharge as the pilot flame, the sustain discharge Ds occurs between the Y electrode Y1 and the X electrode X1. Thereby, the odd number line constituted of the display cell between the X electrode X1 and the Y electrode Y1 is displayed.

On the other hand, the Z electrode Ze sustains the negative voltage −Vs, the sustain discharge DS does not occur between the Y electrode Y1 and the X electrode X2. Thereby, the even number line constituted of the display cell between the Y electrode Y1 and the X electrode X2 is not displayed.

With the above voltage waveform as one cycle, the above described operation is repeated.

The first voltage pulses of the voltages 2 Vs and −2 Vs are applied to the Y electrode Yi (for example, Y1) for sustain discharge. The third voltage pulse with the same polarity as the first voltage pulse of the Y electrode Yi (for example, Y1) is applied to the Z electrode Zo, and thereafter, the same voltage (for example, the ground potential GND) as the X electrode Xi is applied to the Z electrode Zo, whereby discharge between the X electrode Xi (for example, X1) and the Y electrode Yi (for example, Y1) at both sides of the Z electrode Zo is caused. On the other hand, the second voltage pulse with the same polarity as the first voltage pulse of the Y electrode Yi (for example, Y1) is applied to the Z electrode Ze, and thereby, discharge between the Y electrode Yi (for example, Y1) and the X electrode Xi+1 (for example, X2) is suppressed.

The second voltage pulse of the Z electrode Ze has the same pulse width as and half the voltage of the first voltage pulse of the Y electrode Y1. The third voltage pulse of the Z electrode Zo has narrow pulse width with respect to the first voltage pulse of the Y electrode Yi, and has a high voltage with respect to the second voltage pulse of the Z electrode Ze.

As in the first embodiment, this embodiment can also perform interlaced display while fixing the X electrodes to a constant potential (for example, the ground potential) by providing the Z electrodes. In the first embodiment (FIG. 7), at the times t1 and t2, only discharge between the Y electrode and Z electrode is performed, and the subsequent sustain discharge between the Y electrode and the X electrode is not likely to be performed. According to this embodiment (FIG. 9), at the times t1 and t3, pilot discharge is performed by the trigger pulse of the Z electrode Zo, and thereby sustain discharge between the Y electrode and the X electrode can be performed efficiently and reliably at the times t2 and t4.

### Third Embodiment

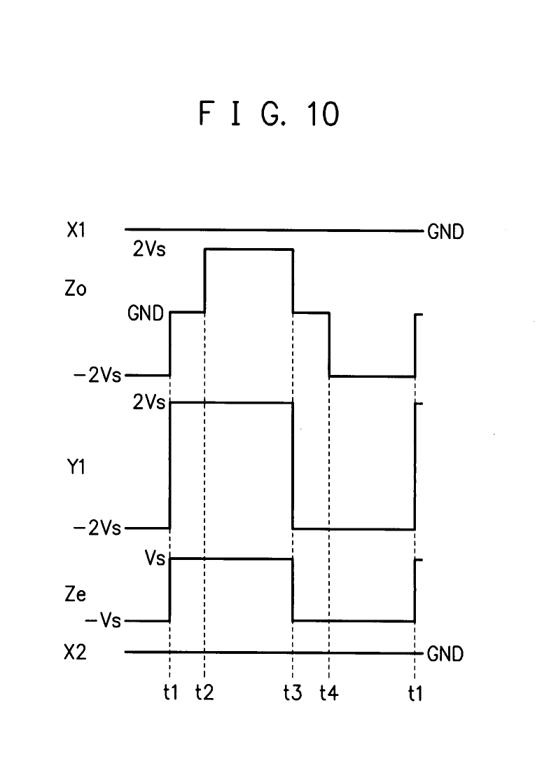

FIG. 10 corresponds to FIG. 7 and is an enlarged diagram of a voltage waveform of the sustain discharge period Ts according to a third embodiment of the present invention. Hereinafter, the respect in which this embodiment differs from the first embodiment will be described. As in the first embodiment (FIG. 7), all the X electrodes X1, X2, . . . are fixed to the ground potential.

At the time t1, the voltage 2 Vs is applied to the Y electrode Y1, the ground potential GND is applied to the Z electrode Zo, and the voltage Vs is applied to the Z electrode Ze. Since the voltage 2 Vs is applied between the Y electrode Y1 and the Z electrode Zo, discharge occurs between the Y electrode Y1 and the Z electrode Zo. The discharge becomes the pilot discharge for sustain discharge of the subsequent time t2.

On the other hand, since the voltage Vs is applied to the Z electrode Ze, only the voltage Vs is applied between the Y electrode Y1 and the Z electrode Ze, and therefore, discharge does not occur between the Y electrode Y1 and the Z electrode Ze. Since only the voltage Vs is applied between the Z electrode Ze and the X electrode X2, discharge does not occur between the Z electrode Ze and the X electrode X2.

On this occasion, the voltage of the Z electrode Zo rises to the ground potential GND with the voltage of the Y electrode Y1, sustains the ground potential GND until discharge between the Y electrode Y1 and the Z electrode Zo occurs, and shifts to the time t2 after the discharge occurs.

Next, at the time t2, the voltage 2 Vs is applied to the Z electrode Zo. Since the voltage 2 Vs is applied between the Z electrode Zo and the X electrode X1, discharge occurs between the Z electrode Zo and the X electrode X1. With the discharge as the pilot flame, the sustain discharge occurs between the Y electrode Y1 and the X electrode X1. Thereby, the odd number line constituted of the display cell between the X electrode X1 and the Y electrode Y1 is displayed.

On the other hand, the Z electrode Ze sustains the voltage Vs, and therefore, the sustain discharge DS does not occur between the Y electrode Y1 and the X electrode X2. Thereby, the even number line constituted of the display cell between the Y electrode Y1 and the X electrode X2 is not displayed.

Next, at the time t3, the negative voltage −2 Vs is applied to the Y electrode Y1, the ground potential GND is applied to the Z electrode Zo, and the negative voltage −Vs is applied to the Z electrode Ze. Since the voltage 2 Vs is applied between the Y electrode Y1 and the Z electrode Zo, discharge occurs between the Y electrode Y1 and the Z electrode Zo. The discharge becomes the pilot discharge for the sustain discharge at the subsequent time t4.

On the other hand, the negative voltage −Vs is applied to the Z electrode Ze, and therefore, only the voltage Vs is applied between the Y electrode Y1 and the Z electrode Ze. Therefore, discharge does not occur between the Y electrode Y1 and the Z electrode Ze. Since only the voltage Vs is applied between the Z electrode Ze and the X electrode X2, discharge does not occur between the Z electrode Ze and the X electrode X2.

On this occasion, the voltage of the Z electrode Zo lowers to the ground potential GND with the voltage of the Y electrode Y1, sustains the ground potential GND until discharge occurs between the Y electrode Y1 and the Z electrode Zo, and shifts to the time t4 after the discharge occurs.

Next, at the time t4, the negative voltage −2 Vs is applied to the Z electrode Zo. Since the voltage 2 Vs is applied between the Z electrode Zo and the X electrode X1, discharge occurs between the Z electrode Zo and the X electrode X1. With the discharge as the pilot flame, sustain discharge occurs between the Y electrode Y1 and the X electrode X1. Thereby, the odd number line constituted of the display cell between the X electrode X1 and the Y electrode Y1 is displayed.

On the other hand, the Z electrode Ze sustains the negative voltage −Vs, the sustain discharge DS does not occur between the Y electrode Y1 and the X electrode X2. Thereby, the even number line constituted of the display cell between the Y electrode Y1 and the X electrode X2 is not displayed.

With the above voltage waveform as one cycle, the above described operation is repeated.

The first voltage pulses of the voltages 2 Vs and −2 Vs are applied to the Y electrode Yi (for example, Y1) for sustain discharge. The voltage with the same polarity as the first voltage pulse of the Y electrode Yi (for example, Y1) is applied to the Z electrode Zo after the same voltage (for example, the ground potential GND) as the X electrode Xi is applied to the Z electrode Zo, whereby discharge between the X electrode Xi (for example, X1) and the Y electrode Yi (for example, Y1) at both sides of the Z electrode Zo is caused. On the other hand, the second voltage pulse with the same polarity as the first voltage pulse of the Y electrode Yi (for example, Y1) is applied to the Z electrode Ze, and thereby, discharge between the Y electrode Yi (for example, Y1) and the X electrode Xi+1 (for example, X2) at the both sides of the Z electrode Ze is suppressed.

The second voltage pulse of the Z electrode Ze has the same pulse width as and half the voltage of the first voltage pulse of the Y electrode Yi.

As in the first embodiment, this embodiment can also perform interlaced display while fixing the X electrodes to a constant potential (for example, the ground potential) by providing the Z electrodes. In the first embodiment (FIG. 7), at the times t1 and t2, only discharge between the Y electrode and Z electrode is performed, and the subsequent sustain discharge between the Y electrode and the X electrode is not likely to be performed. According to this embodiment (FIG. 10), at the times t1 and t3, pilot discharge is performed, and thereby sustain discharge between the Y electrode and the X electrode can be performed efficiently and reliably at the times t2 and t4.

### Fourth Embodiment

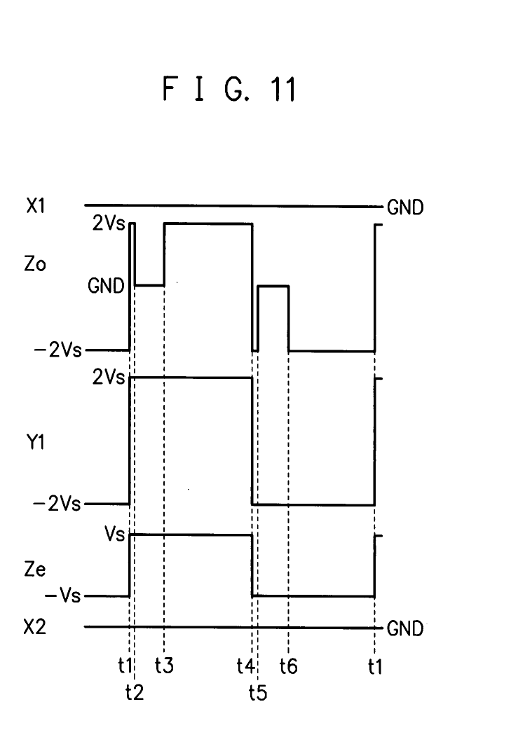

FIG. 11 corresponds to FIG. 7 and is an enlarged diagram of a voltage waveform of the sustain discharge period Ts according to a fourth embodiment of the present invention. Hereinafter, the respect in which this embodiment differs from the first embodiment will be described. As in the first embodiment (FIG. 7), all the X electrodes X1, X2, . . . are fixed to the ground potential. In this embodiment, pulse for the Z electrode Zo is added at the times t1 and t4 to the third embodiment (FIG. 10).

At the time t1, the voltage 2 Vs is applied to the Y electrode Y1 and the Z electrode Zo, and the voltage Vs is applied to the Z electrode Ze. Since the Y electrode Y1 and the Z electrode Zo are at the same potential, the capacitance between the Y electrode Y1 and the Z electrode Zo is in the invisible state.

Next, at the time t2, the ground potential GND is applied to the Z electrode Zo. Since the voltage 2 Vs is applied between the Y electrode Y1 and the Z electrode Zo, discharge occurs between the Y electrode Y1 and the Z electrode Zo. The discharge becomes the pilot discharge for the sustain discharge at the subsequent time t3.

On the other hand, the voltage Vs is applied to the Z electrode Ze, and therefore, only the voltage Vs is applied between the Y electrode Y1 and the Z electrode Ze. Therefore, discharge does not occur between the Y electrode Y1 and the Z electrode Ze. Since only the voltage Vs is applied between the Z electrode Ze and the X electrode X2, discharge does not occur between the Z electrode Ze and the X electrode X2.

Next, at the time t3, the voltage 2 Vs is applied to the Z electrode Zo. Since the voltage 2 Vs is applied between the Z electrode Zo and the X electrode X1, discharge occurs between the Z electrode Zo and the X electrode X1. With the discharge as the pilot flame, the sustain discharge occurs between the Y electrode Y1 and the X electrode X1. Thereby, the odd number line constituted of the display cell between the X electrode X1 and the Y electrode Y1 is displayed.

On the other hand, the Z electrode Ze sustains the voltage Vs, and therefore, the sustain discharge DS does not occur between the Y electrode Y1 and the X electrode X2. Thereby, the even number line constituted of the display cell between the Y electrode Y1 and the X electrode X2 is not displayed.

Next, at the time t4, the negative voltage −2 Vs is applied to the Y electrode Y1 and the Z electrode Zo, and the negative voltage −Vs is applied to the Z electrode Ze. Since the Y electrode Y1 and the Z electrode Zo are at the same potential, the capacitance between the Y electrode Y1 and the Z electrode Zo is in the invisible state.

Next, at the time t5, the ground potential GND is applied to the Z electrode Zo. Since the voltage 2 Vs is applied between the Y electrode Y1 and the Z electrode Zo, discharge occurs between the Y electrode Y1 and the Z electrode Zo. The discharge becomes the pilot discharge for the sustain discharge at the subsequent time t6.

On the other hand, the negative voltage −Vs is applied to the Z electrode Ze, and therefore, only the voltage Vs is applied between the Y electrode Y1 and the Z electrode Ze. Therefore, discharge does not occur between the Y electrode Y1 and the Z electrode Ze. Since only the voltage Vs is applied between the Z electrode Ze and the X electrode X2, discharge does not occur between the Z electrode Ze and the X electrode X2.

Next, at the time t6, the negative voltage −2 Vs is applied to the Z electrode Zo. Since the voltage 2 Vs is applied between the Z electrode Zo and the X electrode X1, discharge occurs between the Z electrode Zo and the X electrode X1. With the discharge as the pilot flame, the sustain discharge occurs between the Y electrode Y1 and the X electrode X1. Thereby, the odd number line constituted of the display cell between the X electrode X1 and the Y electrode Y1 is displayed.

On the other hand, the Z electrode Ze sustains the negative voltage −Vs, and therefore, the sustain discharge DS does not occur between the Y electrode Y1 and the X electrode X2. Thereby, the even number line constituted of the display cell between the Y electrode Y1 and the X electrode X2 is not displayed.

With the above voltage waveform as one cycle, the above described operation is repeated.

As described above, in this embodiment, the pulses for the Z electrode Zo at the times t1 and t4 are added to the third embodiment (FIG. 10). Namely, this embodiment differs from the third embodiment in the respect that by applying the voltage pulses with the same polarities as the first voltage pulse of the Y electrode Yi to the Z electrode Zo at the times t1 and t4 before applying the same voltage (for example, the ground potential) as the X electrode Xi to the Z electrode Zo at the times t2 and t5, discharge between the X electrode Xi (for example, X1) and the Y electrode (for example, Y1) at both sides of the Z electrode Zo is caused. In the other respects, this embodiment is the same as the third embodiment.

In the third embodiment (FIG. 10), at the times t1 and t3, the voltage of the Z electrode Zo can be applied at the ground GND by the LC resonant circuit that is the power recovery circuit. Since the potential difference exists between the Y electrode Y1 and the Z electrode Zo, high impedance is provided, and discharge tends to be unstable.

On the other hand, in this embodiment (FIG. 11), at the times t1 and t4, the voltage of the Z electrode Zo can be applied at the voltages 2 Vs and −2 Vs by the clamp circuit. Since the potential difference does not exists between the Y electrode Y1 and the Z electrode Zo, low impedance is provided, and discharge at the times t2 and t5 can be stabilized.

As in the first embodiment, this embodiment can perform interlaced display while fixing the X electrodes to a constant potential (for example, the ground potential) by providing the Z electrodes. In the first embodiment (FIG. 7), at the times t1 and t2, only discharge between the Y electrode and the Z electrode is performed, and the subsequent sustain discharge between the Y electrode and the X electrode is not likely to be performed. As the third embodiment, this embodiment can perform sustain discharge between the Y electrode and the X electrode efficiently and reliably by performing pilot discharge.

As described above, the plasma display devices according to the first to the fourth embodiments each have the four electrodes that are the X electrode, the Y electrode, the Z electrode and the address electrode. The X electrode is fixed to a constant potential. The Z electrode is provided between the X electrode and the Y electrode, and is the electrode for controlling the discharge between the X electrode and the Y electrode. The Z electrode drive circuit 4 performs interlaced display by alternately displaying the odd-numbered lines L1, L3, . . . and the even-numbered lines L2, L4, . . . by applying different voltages to the odd-numbered Z electrodes Zo and the even-numbered Z electrodes Ze.

For example, in the sustain discharge period Ts, when discharge is caused in the display cell at the side of the Z electrode Zo, the Z electrode Zo is fixed to the ground potential GND, and the voltage with the same polarity as the Y electrode is applied to the Z electrode Ze, while when discharge is caused in the display cell at the side of the Z electrode Ze, the voltage with the same polarity as the Y electrode is applied to the Z electrode Zo, and the Z electrode Ze is fixed to the ground potential GND, whereby discharge of the odd number line and the even number line can be separated. Therefore, interlaced display can be performed.

By providing the Z electrodes, the interlaced display can be performed while the X electrodes are fixed to a constant potential (for example, the ground potential). By fixing the X electrodes to a constant potential, an X electrode drive circuit for driving the X electrodes can be eliminated, and cost can be reduced. By performing the interlaced display, high definition image can be displayed without increasing the number of Y electrodes and scan ICs for driving them.

By providing the fourth electrodes, the interlaced display can be performed while the first electrodes are fixed to a constant potential (for example, the ground potential). By fixing the first electrodes to a constant potential, a first electrode drive circuit for driving the first electrodes can be eliminated, and cost can be reduced. By performing interlaced display, high definition image can be displayed.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device, comprising:
a plurality of first electrodes which are provided on a first substrate;
a plurality of second electrodes which are provided on the first substrate and are for causing discharge between said plurality of first electrodes and themselves;
a plurality of third electrodes which are provided in a second substrate to intersect said first and second electrodes; and
a plurality of fourth electrodes which are provided between said plurality of first and second electrodes and are for controlling discharge between said first and second electrodes,
wherein said plurality of first electrodes are fixed to a constant potential.

2. The plasma display device according to claim 1, further comprising:
a fourth electrode drive circuit which alternately displays odd-numbered lines and even-numbered lines by applying different voltages to odd-numbered fourth electrodes and even-numbered fourth electrodes to perform interlaced display.

3. The plasma display device according to claim 1, further comprising:
a second electrode drive circuit which applies a first voltage pulse to said second electrodes for discharge; and
a fourth electrode drive circuit which causes discharge between said first and second electrodes at both sides of said fourth electrodes by applying the same voltage as said first electrodes to said fourth electrodes between said first and second electrodes, and suppresses discharge between said first and second electrodes at both sides of said fourth electrodes by applying a second voltage pulse with a same polarity as the first voltage pulse of said second electrodes to said fourth electrodes between said first and second electrodes.

4. The plasma display device according to claim 1, further comprising:
a second electrode drive circuit which applies a first voltage pulse to said second electrodes for discharge; and
a fourth electrode drive circuit which causes discharge between said first and second electrodes at both sides of said fourth electrodes by applying a same voltage as said first electrodes to said fourth electrodes between said first and second electrodes after applying a third voltage pulse with a same polarity as the first voltage pulse of said second electrodes to said fourth electrodes between said first and second electrodes, and suppresses discharge between said first and second electrodes at both sides of said fourth electrodes by applying a second voltage pulse with a same polarity as the first voltage pulse of said second electrodes to said fourth electrodes between said first and second electrodes.

5. The plasma display device according to claim 4,
wherein the third voltage pulse has a narrow pulse width with respect to the first voltage pulse.

6. The plasma display device according to claim 4,
wherein the third voltage pulse has a high voltage with respect to the second voltage pulse.

7. The plasma display device according to claim 1, further comprising:
a second electrode drive circuit which applies a first voltage pulse to said second electrodes for discharge; and
a fourth electrode drive circuit which causes discharge between said first and second electrodes at both sides of said fourth electrodes by applying a voltage with a same polarity as the first voltage pulse of said second electrodes to said fourth electrodes between said first and second electrodes after applying a same voltage as said first electrodes to said fourth electrodes between said first and second electrodes, and suppresses discharge between said first and second electrodes at both sides of said fourth electrodes by applying a second voltage pulse with a same polarity as the first voltage pulse of said second electrodes to said fourth electrodes between said first and second electrodes.

8. The plasma display device according to claim 7,
wherein said fourth electrode drive circuit causes discharge between said first and second electrodes at both sides of said fourth electrodes by applying a voltage pulse with a same polarity as the first voltage pulse too said fourth electrodes before applying the same voltage as said first electrodes to said fourth electrodes.

9. The plasma display device according to claim 3,
wherein the second voltage pulse has the same pulse width as the first voltage pulse.

10. The plasma display device according to claim 3,
wherein the second voltage pulse has half the voltage of the first voltage pulse.
